(19) United States
(12) Patent Application Publication
(10) Pub. No.: US 2021/0019434 A1
(43) Pub. Date: Jan. 21, 2021

(54) CLOUD-BASED DATA ACCESS CONTROL

(71) Applicant: Microsoft Technology Licensing, LLC, Redmond, WA (US)

(72) Inventor: Arieh Bibliowicz, Binyamina (IL)

(21) Appl. No.: 16/513,164

(22) Filed: Jul. 16, 2019

(51) Int. Cl. G06F 21/62; G06F 16/903

(52) U.S. Cl. CPC G06F 21/6218; G06F 16/90335

(57) ABSTRACT

Methods, systems and computer program products are provided for cloud-based data access control. Data sensitivity levels are assigned to data. User sensitivity levels are assigned to users. A query sensitivity level to data may be dynamically calculated for a query during query processing. User access to the data may be determined by comparing the calculated query sensitivity level to a user sensitivity level. A query result for the query may be provided to a user that has a user sensitivity level equal to or greater than the query sensitivity level, while a modified or alternate query result (e.g., empty set) may be provided to the user if the user sensitivity level is lower than the query sensitivity level.

### BACKGROUND

Users or applications access data in databases by providing a database with queries against stored data. Data may be stored in a database in the form of tables with rows and columns. A database may define what data a user can access. Currently, access to sensitive data in a database can be limited by controlling the tables a user can access using database permissions, or by controlling the rows that a user can read in a table using row level security.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems and computer program products are provided for cloud-based data access control. Cloud-based database access control may be provided based on a set of sensitivity levels, including query sensitivity levels, data sensitivity levels, and user sensitivity levels. A data owner may assign data sensitivity levels to data. User sensitivity levels may be assigned to users. User sensitivity levels may be accessed by a database (e.g., in response to receiving a user access token) or provided to a database (e.g., in a user access token). A query sensitivity level may be dynamically calculated for a query during (e.g., partial or complete) query processing based on data sensitivity levels. Whether a user may receive a query result generated for the query depends on a relationship between the user sensitivity level assigned to the user and a query sensitivity level calculated for the query.

For example, a query sensitivity level for a query may be a maximum data sensitivity level associated with data pertaining to the query, such as data that is or may be accessed during query execution or that may be provided in a query result. User access to data may be determined, for instance, by comparing a calculated query sensitivity level of a query to a user sensitivity level of a user. A query result for the query may be provided to the user with a user sensitivity level equal to or greater than a query sensitivity level for the query while a modified or alternate query result (e.g., empty set) may be provided to the user with a user sensitivity level lower than a query sensitivity level of the query.

Further features and advantages of the invention, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of a system for cloud-based data access control, according to an example embodiment.

FIG. 2 shows a flowchart of a method for providing cloud-based authentication and authorization to access data, according to an example embodiment.

FIG. 3 shows a flowchart of a method for providing cloud-based data access control, according to an example embodiment.

FIG. 4 shows a flowchart of a method for providing cloud-based data access control, according to an example embodiment.

FIG. 5 shows a block diagram of an example computing device that may be used to implement example embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more embodiments that incorporate the features of the present invention. The scope of the present invention is not limited to the disclosed embodiments. The disclosed embodiments merely exemplify the present invention, and modified versions of the disclosed embodiments are also encompassed by the present invention. Embodiments of the present invention are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an example embodiment of the disclosure, are understood to mean that the condition or characteristic is defined to within tolerances that are acceptable for operation of the embodiment for an application for which it is intended.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Implementations

Data access control may be provided by authentication and authorization. Authentication is process of proving that a user is who the user claims to be. Authentication may challenge a party for legitimate credentials (e.g., username, password, biometric information), for example, as a basis to create a security principal used for identity and access control. Authentication may be referred to as AuthN as a form of shorthand. Authorization is the act of granting an authenticated security principal permission to do something. Authorization may specify what data a party (e.g., user) is allowed to access and what the party can do with it. Authorization may be referred to as AuthZ.

Authentication may be provided by an identity manager or authentication service. An authentication service may provide a security (e.g., ID or access) token to a user who provides legitimate credentials. Applications and resources (e.g., that do not perform their own independent authentication) may require a user to provide an access token, which they may validate (e.g., with the authentication service). Microsoft Azure Active Directory (AD) is an example of a cloud-based identity and access management service provider.

In an example, an access token may be accompanied by metadata about the access token (e.g., for consumption by an application or resource receiving a token). In an example, metadata information may include an expiry time of an access token and the scope(s) for which the access token is valid. This data may permit applications and resources to intelligently cache access tokens without having to parse the access token itself. Access tokens may provide helpful information for use in authentication and authorization validation, such as the user, client, issuer, permissions, etc.

In an example, an access token may comprise a JavaScript Object Notation (JSON) web token (referred to as a JWT) object signed by an authentication provider. A JWT may comprise three pieces (e.g., a header, payload or body and signature). A header may provide information about how to validate a token (e.g., including information about the type of token and how it was signed, such as the key and encryption method used to sign the token). A payload may contain data about a user or application that may be calling an application or resource (e.g., service, database). A signature may comprise raw material that may be used to validate a token. In an example, a token issued by an authentication provider may be signed using an asymmetric encryption algorithm, such as RSA 256. Pieces of a JWT object may be separated by a period and (e.g., separately) Base64 encoded.

A token may be validated (e.g., by an application or resource that received the token), for example, by validating a signature and any claims in the token. A claim may be present, for example, when a value exists to fill it. A signature may be used to validate the authenticity of a token so that it can be trusted by a resource or application. An ID token may be used to validate that a user is who the user claims to be and may be used to obtain additional useful information about the user. An access token may be used to validate user access authorization.

Authorization is the process of determining which securable resources a principal can access, and which operations are allowed for those resources. Authorization may be provided by an authorization provider. An authorization provider may be implemented in a particular application or resource or may be implemented externally applicable across multiple resources.

Authorization may, for example, use role-based access control (RBAC). RBAC may restrict access based on a user's role in or relationship to an enterprise. In an example, RBAC may give an employee or customer access rights to information needed to perform their job or related to their company and prevent them from accessing information that doesn't pertain to their job or company. For example, an enterprise may institute row level security (RLS) to limit access to table-based data in a database.

A security officer may protect information, for example, by persistently tagging or labeling sensitive data in a storage device with classification attributes, e.g., using a user interface showing the classification state(s) of data in a database.

Data sensitivity classification labels may be persistently tagged on columns, for example, using classification metadata attributes provided to a database engine. Metadata may be utilized, for example, during query processing, to calculate a sensitivity of data that is (e.g., actually) or may be (e.g., predicted to be) accessed during processing or that is or may be provided in a query result.

User authentication and authorization may be decoupled from a database and may be specified by others unrelated to data sensitivity specification and to resources. For example, instead of a resource specifying what a user can access, an external specification may specify what a user can access and do with resources. Decoupling user authentication and authorization from resources such as databases permits authentication and authorization definitions (specifications) to apply across a plurality of resources (e.g., inter-resource or cross-resource definition). Resources may validate authorization in a similar way that they validate authentication, which may include concurrently validating authentication and authorization. Decoupling user authentication and authorization from resources such as databases permits centralized management of user identities and access privileges to information and resources (e.g., data in databases).

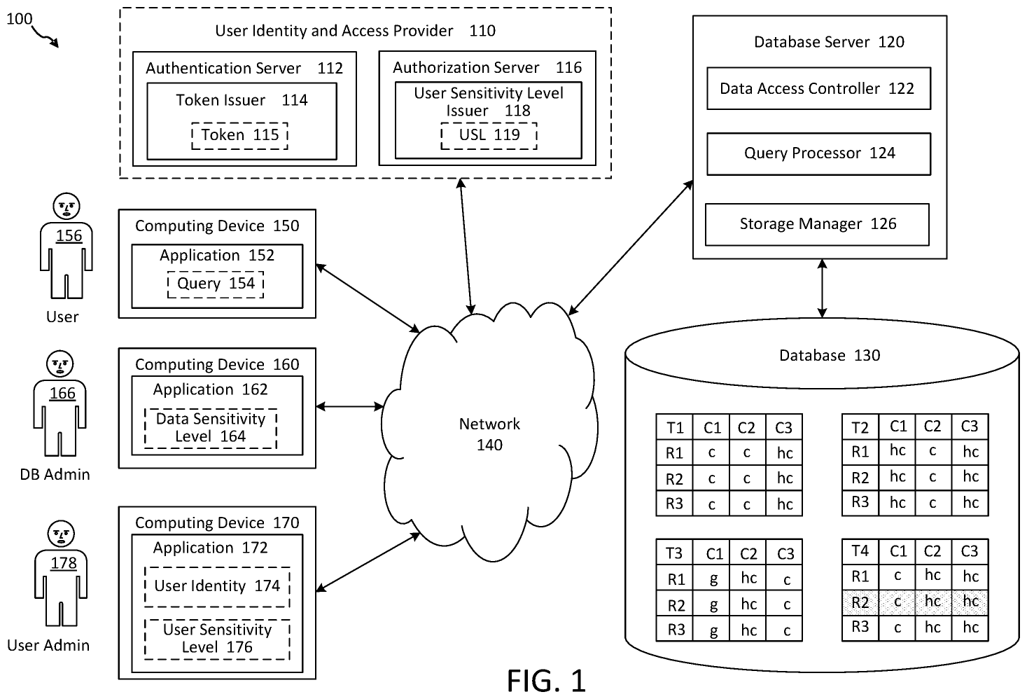

Accordingly, embodiments are described herein for enabling data access control, including authentication and authorization, for results to queries issued to data. Such embodiments are based on sensitivity levels, and may be implemented in various ways. For instance, FIG. 1 shows a block diagram of a system 100 for cloud-based data access control, according to an example embodiment. System 100 presents one of many possible example implementations. System 100 may comprise any number of computing devices and/or servers, such as the example components illustrated in FIG. 1 and optionally one or more additional or alternative devices not expressly illustrated. Other types of computing environments involving secure data access are also contemplated. As shown in FIG. 1, system 100 includes user identity and access provider 110, database server 120, database 130, and computing devices 150, 160, 170, which are communicatively coupled by a network 140. As shown in FIG. 1, a user 156, a database (DB) administrator (admin) 166, and a user admin 178 may interact with system 100 to cause system 100 to perform functions. Further description of the features of system 100 are described as follows.

Network 140 may include one or more of any of a local area network (LAN), a wide area network (WAN), a personal area network (PAN), a combination of communication networks, such as the Internet, and/or a virtual network. In example implementations, user identity and access provider 110, database server 120, database 130 and computing devices 150, 160, 170 may be communicatively coupled to each other via network 140. In an implementation, any one or more of user identity and access provider 110, database server 120, database 130 and computing devices 150, 160, 170 may communicate via one or more application programming interfaces (APIs), and/or according to other interfaces and/or techniques. User identity and access provider 110, database server 120, database 130 and computing devices 150, 160, 170 may each include at least one network interface that enables communications with each other. Examples of such a network interface, wired or wireless, include an IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, a near field communication (NFC) interface, etc. Further examples of network interfaces are described elsewhere herein. Various communications between networked components may utilize, for example, HTTP, Open Authorization (OAuth), which is a standard for token-based authentication and authorization over the Internet). Information in communications may be packaged, for example, as JSON or XML files.

Computing devices 150, 160 and 170 may each comprise any computing device utilized by one or more users (e.g., individual users, family users, enterprise users, governmental users, etc.). Computing devices 150, 160 and 170 may comprise one or more applications, operating systems, virtual machines, storage devices, etc., that may be executed, hosted, and/or stored therein or via one or more other computing devices via network 140. In an example, computing devices 150, 160 and 170 may access one or more server devices, such as user identity and access provider 110 and/or database server 120 to access one or more secured resources, such as database 130. Computing devices 150, 160 and 170 may represent any number of computing devices. User 156, DB admin 166 and user admin 178 may represent any number of persons authorized in their respective roles. Computing devices 150, 160, 170 may each be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone, a wearable computing device, or other type of mobile device, or a stationary computing device such as a desktop computer or PC (personal computer), or a server. Computing devices 150, 160, 170 are not limited to physical machines, but may include other types of machines or nodes, such as a virtual machine. Computing devices 150, 160, 170 may each interface with user identity and access provider 110 and/or database server 120 through APIs and/or by other mechanisms. Any number of program interfaces may coexist on computing devices 150, 160, 170.

Computing device 170 may be operated by user admin 178. User admin 178 may have administrative privileges on all or a portion of user identity and access provider 110. In an example, user identity and access provider 110 may comprise a cloud service available to many customers. In an example, user admin 178 may comprise a user admin in an international enterprise with thousands of employees in many countries with a variety of roles in the enterprise. User admin 178 may use application 172 displayed by computing device 170 to specify user identities (e.g., user identity 174) and user access levels (e.g., user sensitivity level 176) to user identity and access provider 110 via network 140. Application 172 may comprise, for example, a Web application provided by user identity and access provider 110. A user sensitivity level (e.g., rank) may comprise any type of sensitivity specification, e.g., number-based, letter-based, alphanumerical, codewords and so on. In an example, user admin 178 may specify user sensitivities ranging from 0 to 10 in increments of 1. In an example, user admin 178 may specify data sensitivities with one or more labels, such as General (G), Privileged (P), Confidential (C), Highly Confidential (HC), Secret (S), Top Secret (TS) and so on.

Computing device 160 may be operated by DB admin 166. DB admin 166 may have administrative privileges on all or a portion of database server 120. In an example, database server 120 may comprise a cloud service available to many customers. DB admin 166 may protect information, for example, by persistently tagging or labeling sensitive data in a storage device (e.g., database 130) with classification attributes, e.g., using a user interface showing the classification state(s) of data in a database. In an example, DB admin 166 may comprise a DB admin in an international enterprise with thousands of employees in many countries with a variety of roles in the enterprise. DB admin 166 may use application 162 displayed by computing device 160 to manage (e.g., upload or specify) data security (e.g., data sensitivity level 164) to database server 120 via network 140. Application 162 may comprise, for example, a Web application provided by database server 120. A data sensitivity level may comprise any type of sensitivity specification, e.g., number-based, letter-based, alphanumerical, codewords and so on. In an example, DB admin 166 may specify data sensitivities ranging from 0 to 10 in increments of 1. In an example, DB admin 166 may specify data sensitivities with one or more labels, such as General (G), Privileged (P), Confidential (C), Highly Confidential (HC), Secret (S), Top Secret (TS) and so on. Data sensitivity classification labels may be persistently tagged on columns, for example, using classification metadata attributes provided to a database engine. Metadata may be utilized, for example, during query processing, to calculate a sensitivity of data that is (e.g., actually) or may be (e.g., predicted to be) accessed during processing or that is or may be provided in a query result.

DB admin 166 may specify data access logic for database server 120. Data access logic may comprise, for example, query sensitivity logic. Query sensitivity logic, which may be provided by data access controller 122, may calculate query sensitivity levels based on, for example, data accessed by a query or data in a query result. Each DB admin 166 for each cloud-based customer may, for example, select a type of data access calculation performed by data access controller 122 for customer data in database 130.

Computing device 150 may be operated by user 156. User 156 may create and/or consume data stored on database 130. User 156 may, for example, have a role within an enterprise (e.g., engineer, accountant, business unit manager, executive). User 156 may interact with user identity and access provider 110 (e.g., via computing device 150 and network 140) for user authentication and authorization to write, read, process and manipulate data stored on database 130, such as first table T1, second table T2, third table T3 and fourth table T4. User 156 may use application 152 displayed by computing device 150 to submit queries (e.g., query 154) to and receive query results from database server 120. Application 152 may comprise, for example, a Web application provided by database server 120 or a locally executed application (e.g., Microsoft Excel®) that interacts with database server 120 (e.g., through an application programming interface (API) or agent).

A query may comprise, for example, a structured query language (SQL) query or other format query formulated by user 156 or application 152 that seeks data from database 130 as is or rearranged and/or manipulated by one or more operations (e.g., sort, set, filter, quantify, project, partition, join, group, generate, equality, element, conversion, concatenation, aggregation and so on). A query may comprise one or more external user-defined functions.

User identity and access provider 110 may comprise authentication server 112 and authorization server 116. Authentication server 112 and authorization server 116 may be independent, dependent or integrated (e.g., as authentication and authorization server(s)). User authentication and access provider 110 may provide (e.g., cloud-based) user authentication and authorization services to many users that may be associated with many different customers (e.g., enterprises accounts). User authentication and access provider 110 may permit user admins from each customer to control user identity and access information for their respective customers.

User authentication and authorization may be decoupled from resources (e.g., database 130). User sensitivity levels and data sensitivity levels may be specified by different people (or entities (e.g., user admin 178, DB admin 166). Decoupling user authentication and authorization from resources permits authentication and authorization definitions (specifications) to apply across a plurality of resources (e.g., inter-resource or cross-resource definition). Resources may validate authorization in a similar way that they validate authentication, which may include concurrently validating authentication and authorization. Decoupling user authentication and authorization from resources permits centralized management of user identities and access privileges to information and resources. An example of user identity and access provider 110 is Microsoft Azure Active Directory.

Authentication server 112 may provide an identity service or identity provider configured to validate identity information of an entity (e.g., user 156), including but not limited to user login credentials (e.g., a user name and/or password), a user alias, an account number, biometric information, or any other information or credentials that may be used to secure access to a resource (e.g., database 130). Authentication server 112 may comprise a directory or list of users and valid credentials. In an example, a user directory may comprise one or more properties of a user, such as name, address, email, phone number, computer IP address, user sensitivity level, etc. Authentication server 112 may comprise any one or more computing devices, servers, services, local processes, remote machines, web services, etc. for hosting, managing, and/or providing authentication services to users (e.g., user 156, DB admin 166, user admin 178). In an example, authentication server 112 may comprise a server located on an organization's premises and/or coupled to an organization's local network, a remotely located server, a cloud-based server (e.g., one or more servers in a distributed manner), or any other device or service that may host, manage, and/or provide user authentication services. Upon login, authentication server 112 may, for example, determine whether a user is subject to multifactor authentication (MFA).

Authentication server 112 may comprise token issuer 114, which may generate an (e.g., identity or access) token for each user who provides valid credentials. An access token (e.g., provided by authentication server 112) may comprise an indication of one or more authorization privileges (e.g., provided by authorization server 116). As previously discussed, authentication and authorization may be implemented separately or integrated together and may cooperate to provide authentication, authorization and/or validation to one or more (e.g., all) components in example system 100. In an example, an access token may include any object (e.g., a set of data) that enables a computing device, computing environment, and/or applications to access a resource. For example, an access token may be a file or other object that includes one or more of an identifier for the token, an identifier for the associated logon session, an identifier for an application requesting access, a user identifier for the user of the application requesting access, etc. Information in a token may include, for example, information about which group a user belongs to, name, email address, user sensitivity level for resource access and use, etc.

In an example, an access token issued by access token issuer 114 may comprise a JavaScript Object Notation (JSON) web token (referred to as a JWT) object signed by an authentication provider. A JWT may comprise three pieces (e.g., a header, payload or body and signature). A header may provide information about how to validate a token (e.g., including information about the type of token and how it was signed, such as the key and encryption method used to sign the token). A payload may contain data about a user or application that may be calling an application or resource (e.g., service, database). A signature may comprise raw material that may be used to validate a token. In an example, a token issued by an authentication provider may be signed using an asymmetric encryption algorithm, such as RSA 256. Pieces of a JWT object may be separated by a period and (e.g., separately) Base64 encoded. In an example, an access token may be accompanied by metadata about the access token (e.g., for consumption by an application or resource receiving a token). In an example, metadata information may include an expiry time of an access token and the scope(s) for which the access token is valid. This data may permit applications and resources to intelligently cache access tokens without having to parse the access token itself. Access tokens may provide helpful information for use in authentication and authorization validation, such as the user, client, issuer, permissions, etc.

Token issuer 114 may be configured to store each generated access token in a suitable storage device (e.g., local or cloud-based storage). Accordingly, when data application 152 attempts to access a resource (e.g., database 130) by providing an access token to database server 120, data access controller 122 may obtain the access token stored at by authentication server 112 to determine the authenticity of the token received from application 152 prior to granting access to the requested resource (e.g., database 130). Token issuer 114 may be configured to re-transmit a previously generated and unexpired access data access controller 122, such as where token issuer 114 previously generated an authorization token corresponding to application 152 to access the same resource (e.g., database 130).

Authorization server 116 may provide authorization services, for example, by maintaining and providing user permissions. Authentication server 112 may comprise a directory or list of users and user sensitivity levels. Authorization server 116 may comprise any number of computing devices, servers, services, local processes, remote machines, web services, etc. for hosting, managing, and/or providing authorization information to resources (e.g., database 130) by users of computing devices (e.g., computing devices 150, 160, 170). In an example, authorization server 116 may comprise a server located on an organization's premises and/or coupled to an organization's local network, a remotely located server, a cloud-based server (e.g., one or more servers in a distributed manner), or any other device or service that may host, manage, and/or provide access to secured resources (e.g., database 130).

Authorization server 116 may be implemented, for example, as a cloud authorization service. Authorizations provided by authorization server 116 may applicable across multiple resources. Authorization server 116 and/or resource authentication server 112 may comprise affiliated entities and/or may be implemented on a single server or collection of servers. Authorization server 116 may be integrated with or may otherwise cooperate with authentication server 112. In an example, a single token may be issued (e.g., collectively) from authentication server 112 and authorization server 116. For example, authorization server 116 may provide access information to authentication server 112 to embed in an identity token.

Authorization server 116 may comprise user sensitivity level issuer 118, which is configured to issue user sensitivity levels (USLs) and optionally further information. User sensitivity level issuer 118 may issue information independently (e.g., an authorization token or information to user 156 or database 130) and/or may provide information to be embedded in an access token issued by token issuer 114. An authorization token may include any object (e.g., a set of data) that enables a computing device, computing environment, and/or application to access a resource (e.g., database 130). For example, information in the form of an authorization token may comprise a file or other object that includes one or more of an identifier for the token, an identifier for the associated logon session, an identifier for an application requesting access, a user identifier for the user of the application requesting access, and an indication of one or more privileges provided by the authorization token.

In an example, authorization server 116 may provide a user interface (e.g., application 162) for DB admin 166 to specify or otherwise control securable resources that a principal (e.g., user 156) can access and operations allowed for those resources. A data access specification may take the form of one or more user sensitivity levels. A user sensitivity level may comprise any type of sensitivity specification, e.g., number-based, letter-based, alphanumerical, codewords and so on, and indicates a sensitivity level required for users to access a corresponding resource. In an example, user admin 178 may specify user sensitivities ranging from 0 to 10 in increments of 1. In an example, user admin 178 may specify user sensitivity levels with one or more labels, such as General (G), Privileged (P), Confidential (C), Highly Confidential (HC), Secret (S), Top Secret (TS) and so on. In an (e.g., another example), Authorization server 116 may comprise logic (e.g., configured by user admin 178) to determine user sensitivity levels based on information about (e.g., one or more characteristics of) user 156, such as, user role in enterprise, an enterprise or building security clearance for user 156, one or more projects user 156 is assigned to, a trustworthiness rating of user 156 and so on.

Authorization server 116 may implement any type of access control (e.g., based on user sensitivity levels or other access control values). DB admin 166 may define user access control by individual, entity, type of individual or entity, group membership, role, execution context, etc. Authorization may, for example, use role-based access control (RBAC). RBAC may restrict access based on a user's role in or relationship to an enterprise. In an example, RBAC may give an employee or customer access rights to information needed to perform their job or related to their company and prevent them from accessing information that doesn't pertain to their job or company. For example, an enterprise may institute column level security (CLS) and/or row level security (RLS) to limit access to table-based data in a database.

In an example, rows may be associated (e.g., by metadata) with different security levels or other access control information. An RLS function may be applied to query results (e.g., result set or RS) generated by query processor 124, for example, to filter out rows that may have a query sensitivity level or other access beyond a user sensitivity level (USL) 119 or other access limitation of user 156. A filtered result set (1-RS), e.g., a partial result set or other modified result set, may be provided to a user, thereby applying CLS and RLS to queries.

Authorization server 116 may validate authorization information (e.g., user sensitivity levels) for applications and resources (e.g., database 130) that receive information (e.g., tokens) from users (e.g., user 156). In an example, data access controller 122 in database server 120 may receive an access token from user 156 (e.g., along with a query of database 130). Data access controller 122 may validate the signature and claims contained in the token by contacting authorization server 116 (e.g., via network 140).

Database 130 may comprise any type of data storage storing any type of data (e.g., information) that may be secured or unsecured. Database 130 shows an example of one of many possible securable resources with securable data that may be accessed by users and/or applications. Secured resources with accessible data may include any type of resource coupled to a network, including but not limited to computing or processing resources, software resources (e.g., software as a service (SaaS), platform as a service (PaaS), etc.), storage resources (e.g., physical storage devices, local storage devices, cloud-based storages, hard disk drives, solid state drives, random access memory (RAM) devices, etc.), databases, etc. In an example (e.g., as shown in FIG. 1), secured resources may include storage devices, such as database 130, for storing any data that may be referred to, for example, as sensitive, proprietary, confidential, highly confidential, critical, private, secure, and/or not otherwise intended for public dissemination, such as, for example, personal information, educational information, health information, professional information, organizational or company information, banking or other financial records, legal documents, biographic information such as birth certificates, driver's licenses, passports, etc. These examples are a few of many possible examples. Secured resources may include any type of data (including both confidential and non-confidential information) that may be stored in any device, whether locally and/or on a cloud-based storage. In an example, secured resources may be stored in a secure manner, such as via credential (e.g., password) protection, encryption (e.g., public and private key encryption, symmetric keys, etc.), or any other secure manner, e.g., where a data owner or representative may control read and/or write access to data.

Database 130 may be an example of structured data. A database may be an example of structured data overlaid on pages of a page file. A page file may comprise pages (e.g., blocks), which may comprise a storage unit managed by a database engine. Objects of a database may comprise, for example, tables, records, indexes, schemas and/or security information. Associated metadata may indicate which pages are allocated, which objects are stored at which locations of which pages, etc.

Data may be stored in database 130 in any format, including tables. Four examples of table-based information are shown stored in example database 130 (e.g., first, second, third and fourth tables T1, T2, T3 and T4). A database may contain many tables (e.g., hundreds, thousands, millions, tens of millions) with many rows and/or columns (e.g., hundreds, thousands, millions, tens of millions). Specific columns and rows may or may not have data entries. Data sensitivity levels may be implemented, for example, as column level security (CLS) and/or row level security (RLS). One or the other of RLS and CLS may override the other, e.g., using sensitivity levels or other forms of data access security. For example, tables with CLS sensitivity levels may be overridden by RLS sensitivity levels applied to one or more rows. In an example, user 156 may be a customer of an enterprise and token issuer 114 may issue an access token that restricts the customer to the customer's data entry (e.g., a row) in a table of customer data.

For purposes of discussion, data entries in specific rows and columns are not shown. Instead, the sensitivity levels of data in specific rows and columns are shown. A data sensitivity level may comprise any type of sensitivity, e.g., number-based, letter-based, alphanumerical, codewords and so on. In an example, DB admin 166 may specify data sensitivities ranging from 0 to 10 in increments of 1. In an example, data sensitivities may be specified (e.g., by DB admin 166) with one or more labels, such as General (“g”), Privileged (“p”), Confidential (“c”), Highly Confidential (“hc”), Secret (“s”), Top Secret (“ts”) and so on. Data sensitivity classification labels may be persistently tagged on columns, for example, using classification metadata attributes provided to a database engine. Metadata may be utilized, for example, during query processing, to calculate a sensitivity of data that is (e.g., actually) or may be (e.g., predicted to be) accessed during processing or that is or may be provided in a query result.

For purposes of discussing examples, first table T1 is shown with CLS sensitivity levels of c for first and second columns C1 and C2, and hc for third column C3. Second table T2 is shown with CLS sensitivity levels of hc for first column C1, c for second column C2 and hc for third column C3. Third table T3 is shown with CLS sensitivity level g for first column C1, hc for second column C2 and c for third column C3. Fourth table T4 is shown with CLS sensitivity levels c for first column C1, hc for second and third columns C2 and C3. Fourth table T4 second row R2 is shaded as an indication of RLS being applied to second row R2.

Database server 120 may support operations by and interactions with database 130. Database server 120 may be referred to as a database engine or management system (DBMS) for database 130. An example of Database server 120 is Microsoft Azure SQL Server. Database server 120 may manage storing, processing, and securing data in database 130. Database server 120 may provide application programming interfaces (APIs) for application 152 and application 162 to interact with database server 120. Database server 120 may comprise, for example, data access controller 122, query processor 124 and database engine 126. These components are representative examples of many components that may be separate or integrated in database server 120.

Storage manager 126 may manage data and operations involving data in database 130. Operations may include writing, reading, updating and deleting data in database 130, managing data structures, managing indexing, monitoring database performance, maintain log files, etc. Storage manager 126 may provide an interface between query processor 124 and database 130. Storage manager 126 may provide an interface between data access controller 122 and database 130, e.g., to associate (e.g., via metadata) stored data with data sensitivity levels that DB admin 166 specifies to data access controller 122. Storage manager 126 may provide an interface between data query processor 124 and database 130, e.g., to provide database indexes and to access stored data for query processor 124.

Query Processor 124 may process queries (e.g., query 154) against data in database 130. Query processor 124 may be configured to receive queries (e.g., query 154). A query may be provided in any form that query processor 124 may be configured to recognize. Queries may range from simple to complex. In an example, a simple query may request one or more specific columns or rows of data in one or more tables without processing. In an example, a complex query may include one or more user-defined functions that require execution to determine which data may be accessed. A query may be expressed in a query language, such as structured query language (SQL). Query processing may occur in stages between receiving a query and providing a query result. Stages may variously be referred to as, for example, parsing query statements, algebrizing, binding or normalizing a query (e.g., into actual database rows and columns) to generate a query tree, optimizing query statements, compiling a query plan (e.g., during compilation time) into executable code and executing query code (e.g., during runtime) to generate a result. Code may comprise, for example, data access, joins, selections, projections, grouping, and aggregation.

Data access controller 122 may comprise logic to control access to some or all data in database 130. Access control may be provided based on a security configuration of data access controller 122. Data access controller 122 may have one or more security configurations (e.g., one or more configurations for each customer and/or user of database 130). A security configuration (e.g., data access control logic) may be provided, for example, by DB admin 166. Data access controller 122 may be configured to make data access control decisions (e.g., for particular users and/or applications) based on authentication information (e.g., token 115), authorization information such as a user sensitivity level (e.g., USL 119), data sensitivity levels and/or query sensitivity levels (e.g., for query 154). Data access controller 122 may have default access control logic. In an example, a (e.g., each) DB admin 166 for each cloud-based customer may, for example, accept default logic and/or specify data access logic (e.g., select a type of data access calculation) performed by data access controller 122 for customer data in database 130.

In an example, data access controller 122 may receive an access token (e.g., token 115), which may accompany a query (e.g., query 154). A token may comprise authentication information (e.g., provided by authentication server 112). A token may or may not comprise authorization information (e.g., user sensitivity level, such as USL 119, provided by authorization server 116). Data access controller 122 may be configured to validate authentication information (e.g., with authentication server 112) and authorization information (e.g., with authorization server 116). In an example (e.g., where authentication and/or authorization information may be invalid, expired or missing), data access controller 122 may indicate that user 156 or application 152 must provide valid authentication and/or authorization information, which may cause user 156 and/or application 152 to acquire or reacquire such information and provide it to data access controller 122. In an example, data access controller 122 may be configured to request user authorization information (e.g., from authorization server 116) in response to a data access request (e.g., a query) and/or in response to receiving an access token (e.g., when user authorization information is not provided, is not already available to data access controller 122 or may be expired).

In an example, an application (e.g., application 152) may seek to access a resource or information that may be stored in a resource (e.g., database 130). For example, application 152 may provide a query to database server 120 seeking data that user 156 selected. Database server 120 may determine (e.g., in response to query 154) whether application 152 and/or user 156 are authorized to access data pertaining to the query. Database server may request a token if one wasn't provided with query 154. A token may be, for example, a long or short live token. Database server 120 may send a request to user identity and access provider 110 or access authorization server 116 to validate information in token 154 and/or to obtain additional information (e.g., a user sensitivity level) that may not have been provided in token 154.

Data access control logic may be configured to provide one or more (e.g., admin configurable) dynamic calculations of a query sensitivity level and/or comparison of a query sensitivity level to a user sensitivity level. Data access controller 120 may be configured to (e.g., dynamically) determine a query sensitivity level based on, for example, information available at one or more stages of query processing (e.g., information available before, during and/or after a query processing stage, such as parsing, compiling, execution). Query sensitivity calculation logic may calculate query sensitivity levels based on, for example, (a) data sensitivity levels of data that would be or are accessed by a query or (b) data sensitivity levels of data that would be or are in a query result.

Data access controller 122 may be configured to deny data access (e.g., by a user and/or application) based on failed authentication and/or authorization. In an example, data access controller 122 may be configured to deny data access (e.g., by a user and/or application) based on a (a) failure to provide or validate authentication and/or authorization information (e.g., claims and/or signature in a token) and/or (b) a user sensitivity level lower than a query sensitivity level. Data access may be denied, for example, by providing an empty set and/or selectively removing sensitive data from a query result. In an example (e.g., with reference to an example query of example tables T1, T2, T3, T4 in database 130), a user (e.g., user 156) with user sensitivity level c may be provided with an empty set or a modified set limited to data with data sensitivity levels of g and c, for example, when a query involves data with (a) an hc data sensitivity level that would be or is (a) accessed for query processing or (b) in a query result. In an example, application of row level security (RLS) may (e.g., further) deny access to second row R2 in fourth table T4, for example, when user 156 has an enterprise role prohibited from accessing RLS applied to second row R2 in fourth table T4. This may be implemented, for example, with partial or full denial of access to a query result that would otherwise be generated and provided upon execution of the query.

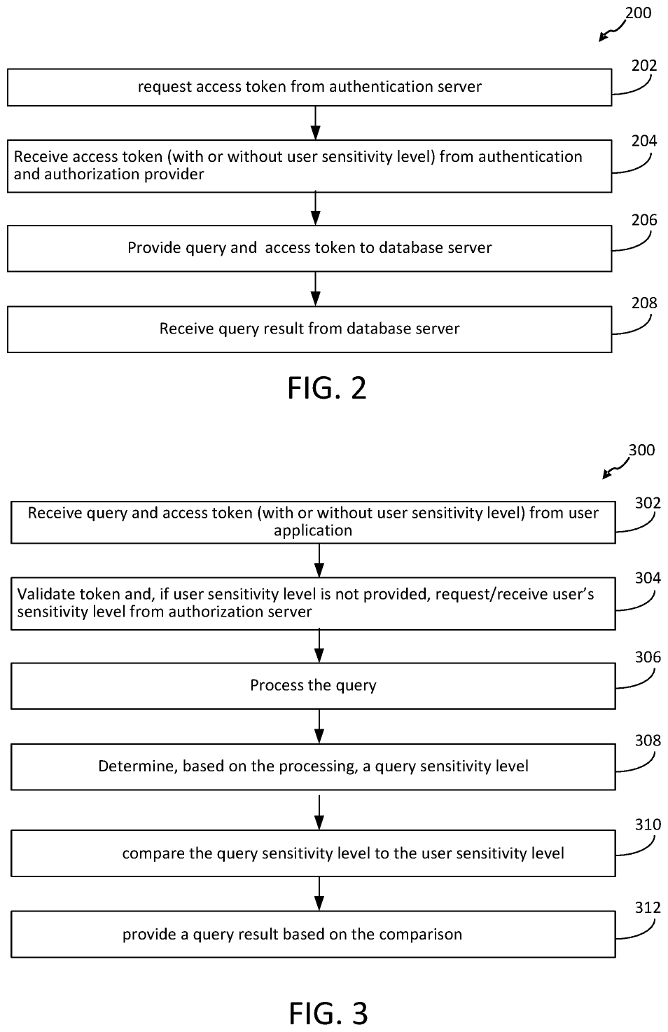

Implementations are not limited to the example shown in FIG. 1. Any number of computing devices and/or servers (including but not limited to machines and/or virtual machines) may be coupled in any manner via any type of computing environment. For example, one or more of computing device, server or storage components may be co-located, located remote from each other, combined or integrated on or distributed across one or more real or virtual machines. For example, authentication server 112 and authorization server 116 may be merged into an authentication and authorization server. Example system 100 or components therein may operate, for example, according to example methods presented in FIGS. 2-4.

Embodiments may also be implemented in processes or methods. For example, FIG. 2 shows a flowchart of a method 200 for providing cloud-based authentication and authorization to access data, according to an example embodiment. Embodiments disclosed herein and other embodiments may operate in accordance with example method 200. Method 200 comprises steps 202-208. However, other embodiments may operate according to other methods. Other structural and operational embodiments will be apparent to persons skilled in the relevant art(s) based on the foregoing discussion of embodiments. No order of steps is required unless expressly indicated or inherently required. There is no requirement that a method embodiment implement all of the steps illustrated in FIG. 2. FIG. 2 is simply one of many possible embodiments. Embodiments may implement fewer, more or different steps.

Method 200 comprises step 202. In step 202, an access token may be requested from an authentication server. For example, as shown in FIG. 1, user 156 may (e.g., using computing device 150) request an access token from user identity and access provider 110. User 156 may (e.g., as part of the request) provide credentials (e.g., user name and password, biometric information and so on).

In step 204, an access token (with or without user sensitivity level) may be received from an authentication and authorization provider. For example, as shown in FIG. 1, user identity and access provider 110 may process user credentials. Authorization server 116 may determine a user sensitivity level associated with the user. User sensitivity level issuer 118 may issue USL 119, for example, by providing it to token issuer 114. Token issuer 114 may issue token 115 with USL 119 embedded therein. User 156 may receive token 115 with USL 119 embedded therein. In an alternative example, user 156 may receive token 115 without USL 119. As previously indicated, data access controller 122 may be configured to access USL 119 in response to receiving token 115 and/or query 154, e.g., from computing device 150.

In step 206, a query and access token may be provided to a database server. For example, as shown in FIG. 1, user 156 may (e.g., using computing device 150) provide query 154 and token 115 to database server 120.

In step 208, a query result may be received from a database server. For example, as shown in FIG. 1, user 156 may (e.g., via computing device 150) receive a query result from database server 120. Data access controller 122 may permit or deny (e.g., in whole or in part) access to data in database 130 that was or may have been accessed during execution of the query or that was or may have been in a query result that was or may have been generated by query processor 124 in response to query 154. For example, data access controller 122 may provide an empty set as a query result to query 154 if USL 119 is less than the query sensitivity level calculated for query 154 by data access controller 122.

FIG. 3 shows a flowchart of a method 300 for providing cloud-based data access control, according to an example embodiment. Embodiments disclosed herein and other embodiments may operate in accordance with example method 300. Method 300 comprises steps 302-312. However, other embodiments may operate according to other methods. Other structural and operational embodiments will be apparent to persons skilled in the relevant art(s) based on the foregoing discussion of embodiments. No order of steps is required unless expressly indicated or inherently required. There is no requirement that a method embodiment implement all of the steps illustrated in FIG. 3. FIG. 3 is simply one of many possible embodiments. Embodiments may implement fewer, more or different steps.

Method 300 comprises step 302. In step 302, a query and access token (with or without user sensitivity level) may be received from a user application. For example, as shown in FIG. 1, database server 120 may receive query 154 and access token 115 from computing device 150. Token 115 may or may not comprise USL 119.

In step 304, the token may be validated and, if user sensitivity level is not provided, the user's sensitivity level may be requested and received from an authorization server. For example, as shown in FIG. 1, data access controller 122 may validate the claims and signature in token 115 with token issuer 114 and may validate USL 119 with user sensitivity level issuer 118. Data access controller 122 may (e.g., alternatively), request USL 119 from user sensitivity level issuer 118, for example, by providing validated information in token 115 to authorization server 116.

In step 306, the query may be processed. For example, as shown in FIG. 1, query processor 124 may process query 154. Query processor 124 may process query 154 to one or more stages, e.g., from parsing to execution, for example, based on data access control logic. Determinations may by variously possible at one or more stages to determine data that would be or is accessed or would be or is in a query result and data sensitivity levels associated with the data. Data access controller 122 may determine, for example, during parsing, that data to be accessed has a higher sensitivity level than USL 119, in which case, query processing may stop at parsing and an empty set may be returned as a query result to query 154. In other cases (e.g., with more complex queries), query processing may proceed through execution before data accessed or in results and associated sensitivity levels may be known.

In step 308, a query sensitivity level may be determined based on the processing. For example, as shown in FIG. 1, data access controller 122 may be configured to calculate a query sensitivity level based on data sensitivity levels of data that was or could be accessed to generate or is in a query result. For example, some data accessed may not wind up in a query result. A configuration may determine how a query sensitivity level is calculated by data access controller 122. DB admin 166 may select from multiple options and/or may supply calculation logic. In an example, query 154 may pertain to first column C1 of first table T1, second column C2 of second table T2 and second column C2 of third table T3. Query processor 124 may process query 154 to a stage where data access controller 122 determines that only first column C1 of first table T1 and second column C2 of second table T2 would be in a query result (e.g., second column C2 of third table T3 is accessed but not in a query result). Data access controller 122 may be configured to calculate a query sensitivity level based on data sensitivity levels in a query result and may be configured to calculate a query sensitivity level based on the highest sensitivity level present in a query result, which may result in a calculated sensitivity level of c (confidential).

In step 310, the query sensitivity level may be compared to the user sensitivity level. For example, as shown in FIG. 1, data access controller 122 may compare USL 119 to the calculated query sensitivity level c.

In step 312, a query result may be provided based on the comparison. For example, as shown in FIG. 1, data access controller 122 may provide a query result generated by query processor 124, for example, when USL 119 is the same or greater level than the calculated query sensitivity level c. Data access controller 122 may deny access to a query result generated by query processor 124 in whole or in part, for example, when USL 119 is a lower level (e.g., level g or general) than the calculated query sensitivity level c. In an example, data access controller 122 may provide an empty set as a query result instead of a query result generated by query processor 124. Data access controller 122 may override query processor 124 as necessary to carry out one or more data access policies, which may be configured, for example, by DB admin 166.

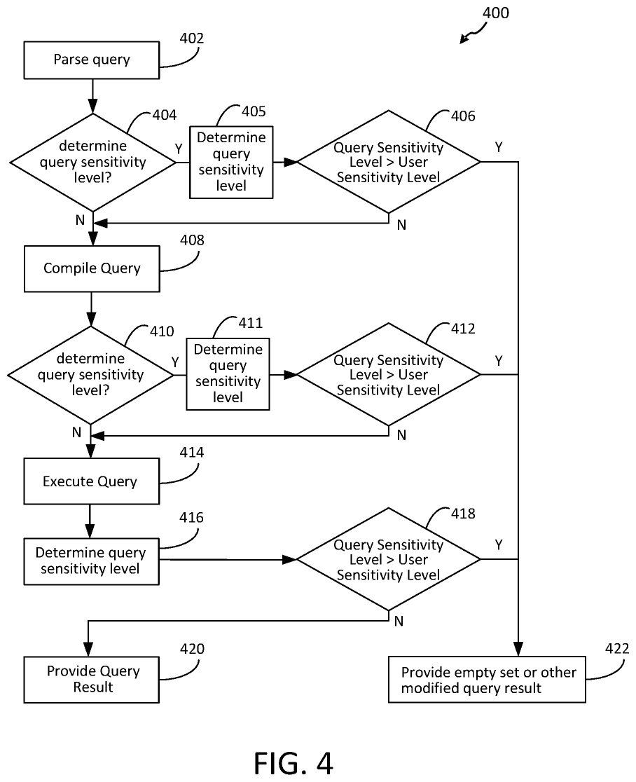

FIG. 4 shows a flowchart of a method 400 for providing cloud-based data access control, according to an example embodiment. Embodiments disclosed herein and other embodiments may operate in accordance with example method 400. Method 400 comprises steps 402-422. However, other embodiments may operate according to other methods. Other structural and operational embodiments will be apparent to persons skilled in the relevant art(s) based on the foregoing discussion of embodiments. No order of steps is required unless expressly indicated or inherently required. There is no requirement that a method embodiment implement all of the steps illustrated in FIG. 4. FIG. 4 is simply one of many possible embodiments. Embodiments may implement fewer, more or different steps.

Method 400 comprises step 402. In step 402, a query may be parsed. For example, as shown in FIG. 1, query processor 124 may parse query 154.

In step 404, a decision may be made whether a query sensitivity level may be determined based on the parsed query. For example, as shown in FIG. 1, query processor 124 may indicate to data access controller 122 whether a query sensitivity level may be determined based on the parsed query. In an example, query processor 124 may write an indication of query data and/or data sensitivities to a buffer and/or otherwise communicate such information to data access controller 122. Data access controller 122 may check the buffer and/or communication to determine whether to calculate a query sensitivity level. Query processor 124 and/or data access controller 122 may request data sensitivity levels of the data from storage manager 126. In an example, a simple query requesting data may be determined based on parsing while a complex query may require further processing. Query processor 124 may or may not be configured to pause or terminate processing based on an indication by data access controller 122 that it is calculating or has calculated a query sensitivity level or is determining or has determined whether a calculated query sensitivity level is greater than USL 119. Step 404 may proceed to step 405, for example, when a query sensitivity level may be determined based on parsing. Step 404 may proceed to step 408, for example, when a query sensitivity level may not be determined based on parsing. Query processor 124 may or may not be configured to pause or terminate processing based on an indication by data access controller 122.

In step 405, a query sensitivity level may be determined. For example, as shown in FIG. 1, data access controller 122 may apply its configured access control logic to calculate a query sensitivity level based on query sensitivity levels of data in database 130 that pertain to query 154. A decision whether to calculate a query sensitivity level may be based on, for example, a data access control logic configuration. In an example, data access controller 122 may proceed with query processing without determining a query sensitivity level, for example, when it is configured to provide an executed query result limited to data having sensitivities less than or equal to USL 119.

In step 406, a decision may be made whether a query sensitivity level is greater than a user sensitivity level. For example, as shown in FIG. 1, data access controller 122 may determine whether the calculated query sensitivity level is greater than USL 119. Step 406 may proceed to step 422, for example, when the calculated query sensitivity level is greater than USL 119. Step 406 may proceed to step 408, for example, when the calculated query sensitivity level is equal to or less than USL 119. A decision whether to proceed with query processing or end query processing may be based on, for example, a data access control logic configuration. For example, data access controller 122 may proceed with query processing when it is configured to provide an executed query result limited to data having sensitivities less than or equal to USL 119 and it was determined that at least some data responsive to query 154 has a sensitivity level equal to or lower than USL 119.

In step 408, a query may be compiled. For example, as shown in FIG. 1, query processor 124 may compile query 154. Compiling may involve multiple stages to convert the query into an executable program. The conversion or translation process may include, for example, lexical, syntactical and semantical analyses of the query, query optimization and code (e.g., executable program) generation.

In step 410, a decision may be made whether a query sensitivity level may be determined based on the compiled query. For example, as shown in FIG. 1, query processor 124 may indicate to data access controller 122 whether a query sensitivity level may be determined based on the partially or completely compiled query. Query processor 124 may determine data that may be accessed by query execution during one or more stages of query compiling. In an example, query processor 124 may write an indication of query data and/or data sensitivities to a buffer and/or otherwise communicate such information to data access controller 122. Data access controller 122 may check the buffer and/or communication to determine whether query data is known to calculate a query sensitivity level. Query processor 124 and/or data access controller 122 may request data sensitivity levels of the data from storage manager 126. Query processor 124 may or may not be configured to pause or terminate processing based on an indication by data access controller 122 that it is calculating or has calculated a query sensitivity level or is determining or is determining or has determined whether a calculated query sensitivity level is greater than USL 119. Step 410 may proceed to step 411, for example, when a query sensitivity level may be determined based on compiling. Step 410 may proceed to step 414, for example, when a query sensitivity level may not be determined based on parsing.

In step 411, a query sensitivity level may be determined. For example, as shown in FIG. 1, data access controller 122 may apply its configured access control logic to calculate a query sensitivity level based on query sensitivity levels of data in database 130 that pertain to query 154. A decision whether to calculate a query sensitivity level may be based on, for example, a data access control logic configuration. In an example, data access controller 122 may proceed with query processing without determining a query sensitivity level, for example, when it is configured to provide an executed query result limited to data having sensitivities less than or equal to USL 119.

In step 412, a decision may be made whether a query sensitivity level is greater than a user sensitivity level. For example, as shown in FIG. 1, data access controller 122 may determine whether the calculated query sensitivity level is greater than USL 119. Step 412 may proceed to step 422, for example, when the calculated query sensitivity level is greater than USL 119. Step 412 may proceed to step 414, for example, when the calculated query sensitivity level is equal to or less than USL 119. A decision whether to proceed with query processing or end query processing may be based on, for example, a data access control logic configuration. For example, data access controller 122 may proceed with query processing when it is configured to provide an executed query result limited to data having sensitivities less than or equal to USL 119 and it was determined that at least some data responsive to query 154 has a sensitivity level equal to or lower than USL 119.

In step 414, a query may be executed. For example, as shown in FIG. 1, query processor 124 may execute the executable program generated during query compiling to generate a query result comprising data requested by query 154.

In step 416, a query sensitivity level may be determined. For example, as shown in FIG. 1, data access controller 122 may apply its configured access control logic to calculate a query sensitivity level based on query sensitivity levels of data in database 130 that pertain to query 154.

In step 418, a decision may be made whether a query sensitivity level is greater than a user sensitivity level. For example, as shown in FIG. 1, data access controller 122 may determine whether the calculated query sensitivity level is greater than USL 119. Step 418 may proceed to step 422, for example, when the calculated query sensitivity level is greater than USL 119. Step 418 may proceed to step 420, for example, when the calculated query sensitivity level is equal to or less than USL 119.

In step 420, a query result may be provided. For example, as shown in FIG. 1, database server 120 (e.g., a front-end of database server 120) may return a query result generated by query processor 124.

In step 422, an empty set or other modified query result may be provided. For example, as shown in FIG. 1, database server 120 (e.g., a front-end of database server 120) may return as a query result an empty set or a modified query result without data having sensitivity levels greater than USL 119.

### III. Example Computing Device Embodiments

As noted herein, the embodiments described, along with any modules, components and/or subcomponents thereof, as well as the flowcharts/flow diagrams described herein, including portions thereof, and/or other embodiments, may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC), a field programmable gate array (FPGA), and/or an application specific integrated circuit (ASIC). A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

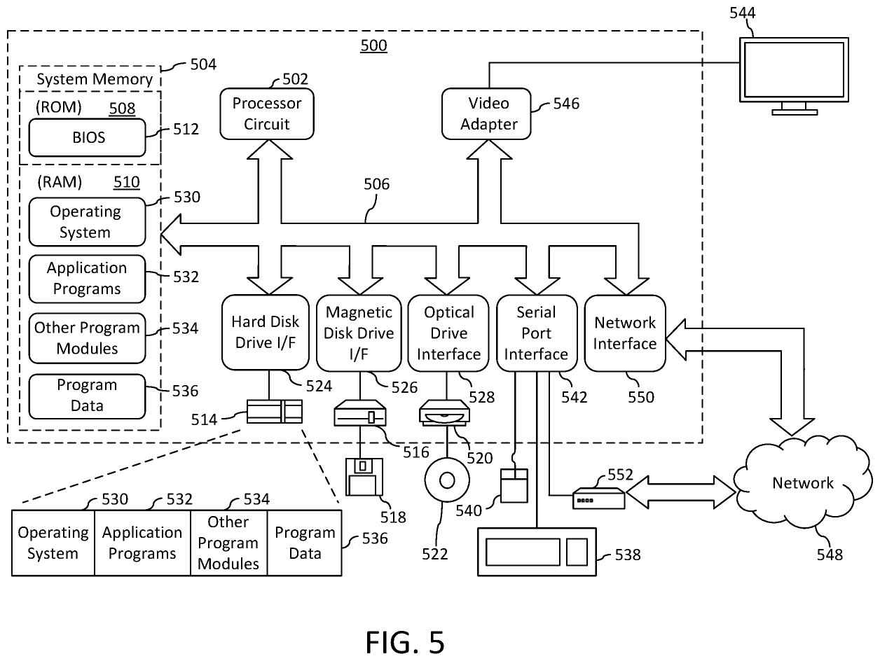

FIG. 5 shows an exemplary implementation of a computing device 500 in which example embodiments may be implemented. For instance, one or more of computing devices 150, 160, and 170, and database server 120 may include features of computing device 500. Consistent with all other descriptions provided herein, the description of computing device 500 is a non-limiting example for purposes of illustration. Example embodiments may be implemented in other types of computer systems, as would be known to persons skilled in the relevant art(s).

As shown in FIG. 5, computing device 500 includes one or more processors, referred to as processor circuit 502, a system memory 504, and a bus 506 that couples various system components including system memory 504 to processor circuit 502. Processor circuit 502 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 502 may execute program code stored in a computer readable medium, such as program code of operating system 530, application programs 532, other programs 534, etc. Bus 506 represents one or more of any of several types of bus structures, including a memory bus or memory controller, a peripheral bus, an accelerated graphics port, and a processor or local bus using any of a variety of bus architectures. System memory 504 includes read only memory (ROM) 508 and random-access memory (RAM) 510. A basic input/output system 512 (BIOS) is stored in ROM 508.

Computing device 500 also has one or more of the following drives: a hard disk drive 514 for reading from and writing to a hard disk, a magnetic disk drive 516 for reading from or writing to a removable magnetic disk 518, and an optical disk drive 520 for reading from or writing to a removable optical disk 522 such as a CD ROM, DVD ROM, or other optical media. Hard disk drive 514, magnetic disk drive 516, and optical disk drive 520 are connected to bus 506 by a hard disk drive interface 524, a magnetic disk drive interface 526, and an optical drive interface 528, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 530, one or more application programs 532, other programs 534, and program data 536. Application programs 532 or other programs 534 may include, for example, computer program logic (e.g., computer program code or instructions) for implementing user identity and access provider 110, database server 120, database 130, authentication server 112, token issuer 114, authorization server 116, user sensitivity level issuer 118, data access controller 122, query processor 124, storage manager 126, application 152, application 162, application 172, method 200, method 300, and/or method 400 (including any suitable step of methods 200, 300, or 400) and/or further example embodiments described herein.

A user may enter commands and information into the computing device 500 through input devices such as keyboard 538 and pointing device 540. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 502 through a serial port interface 542 that is coupled to bus 506, but may be connected by other interfaces, such as a parallel port, game port, or a universal serial bus (USB).

A display screen 544 is also connected to bus 506 via an interface, such as a video adapter 546. Display screen 544 may be external to, or incorporated in computing device 500. Display screen 544 may display information, as well as being a user interface for receiving user commands and/or other information (e.g., by touch, finger gestures, virtual keyboard, etc.). In addition to display screen 544, computing device 500 may include other peripheral output devices (not shown) such as speakers and printers.

Computing device 500 is connected to a network 548 (e.g., the Internet) through an adaptor or network interface 550, a modem 552, or other means for establishing communications over the network. Modem 552, which may be internal or external, may be connected to bus 506 via serial port interface 542, as shown in FIG. 5, or may be connected to bus 506 using another interface type, including a parallel interface.

As used herein, the terms “computer program medium,” “computer-readable medium,” and “computer-readable storage medium” are used to refer to physical hardware media such as the hard disk associated with hard disk drive 514, removable magnetic disk 518, removable optical disk 522, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media that are separate and non-overlapping with embodiments directed to computer-readable storage media.

As noted above, computer programs and modules (including application programs 532 and other programs 534) may be stored on the hard disk, magnetic disk, optical disk, ROM, RAM, or other hardware storage medium. Such computer programs may also be received via network interface 550, serial port interface 542, or any other interface type. Such computer programs, when executed or loaded by an application, enable computing device 500 to implement features of example embodiments described herein. Accordingly, such computer programs represent controllers of the computing device 500.

Example embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. Example Embodiments

Methods, systems and computer program products are provided for cloud-based data access control. Cloud-based database access control may be provided based on a query sensitivity level, data sensitivity levels and a user sensitivity level. A data owner may assign data sensitivity levels to data. User sensitivity levels may be assigned external to a database. User sensitivity levels may be accessed by a database (e.g., in response to receiving a user access token) or provided to a database (e.g., in a user access token). A query sensitivity level may be dynamically calculated during (e.g., partial or complete) query processing. For example, a query sensitivity level may be a maximum data sensitivity level associated with data pertaining to a query, such as data that is or may be accessed during query execution or that may be provided in a query result. User access to data may be determined, for example, by comparing a calculated query sensitivity level to a user sensitivity level. A query result may be provided to a user with a user sensitivity level equal to or greater than a query sensitivity level while a modified or alternate query result (e.g., empty set) may be provided to a user with a user sensitivity level lower than a query sensitivity level.

In an example, a method of (e.g., cloud-based) data access control (e.g., performed by at least one computing device) may comprise, for example, receiving a query (e.g., from an application or a user) pertaining to stored data associated with at least one data sensitivity level. For example, stored data may comprise a first data (e.g., data in a first column of a first table) associated with a first data sensitivity level and a second data (e.g., data in a column of a second table) associated with a second data sensitivity level, where the data sensitivity levels may be the same or different. The method may (e.g., also) comprise receiving a user sensitivity level for a user. The method may comprise processing the query; determining, based on the processing of the query pertaining to the stored data associated with the at least one data sensitivity level, a query sensitivity level associated with the query; comparing the user sensitivity level to the query sensitivity level (e.g., to determine whether the user is authorized to receive a query result based on an execution of the query); and providing a query result based on the comparison.

In an example, the data access control may be cloud-based and resource-independent with autonomous specification of user and data sensitivity levels. The data sensitivity level may be specified by a data sensitivity provider. The user sensitivity level may be specified by a user sensitivity provider. The data sensitivity provider may be different from the user sensitivity provider (e.g., providing a separation of user sensitivity and data sensitivity concerns). The query sensitivity level may be dynamically calculated by a cloud database server.

In an example, the query result may comprise an empty set or other data access controlled query result, for example, when the comparison indicates the query sensitivity level is higher than the user sensitivity level. The query result may comprise a query result based on execution of the query, for example, when the comparison indicates the query sensitivity level is the same or lower than the user sensitivity level.

In an example, the query sensitivity level may be determined before a query result is determined based on execution of the query.

In an example, the query sensitivity level may be determined based on parsing the query, compiling the query or executing the query.

In an example, the query sensitivity level may be determined based on stored data that would be or is accessed to execute the query.

In an example, the query sensitivity level may be determined based on stored data that would be or is in a query result based on execution of the query.

In an example, the query sensitivity level may be determined based on a maximum data sensitivity level in the at least one data sensitivity level associated with stored data that would be or is (i) read or accessed during the processing of the query or (ii) in the query result based on execution of the query.

In an example, the user sensitivity may be received in an access token (e.g., provided by a user or application) or received from a user sensitivity provider.

In an example of a system, a database server may comprise, for example, a database, a query processor and a data access controller. In an example, a database may be configured to store data associated with at least one data sensitivity level, the stored data comprising a first data associated with a first data sensitivity level and a second data associated with a second data sensitivity level. In an example, a query processor may be configured to receive a query; and process the query to generate a query result. In an example, a data access controller may be configured to receive a user access token associated with a user; receive a user sensitivity level for the user; determine a query sensitivity associated with the query; compare the user sensitivity to the query sensitivity; and provide data access control based on the comparison.

In an example, the user access token may comprise the user sensitivity level.

In an example, the query sensitivity level may be determined before the query processor generates the query result (e.g., based on parsing the query, compiling the query or partially executing the query).

In an example, data access control may comprise controlling the query result to provide an empty set or other data access controlled query result when the comparison indicates the query sensitivity level is higher than the user sensitivity level.

In an example, the query sensitivity level may be based on a maximum data sensitivity level in the at least one data sensitivity level associated with stored data that would be or is (i) read or accessed during the processing of the query or (ii) in the query result based on execution of the query.

In an example, a computer-readable storage medium may have program instructions recorded thereon that, when executed by a processing circuit, perform a method comprising: receiving a query pertaining to stored data associated with at least one data sensitivity level; receiving a user sensitivity level for a user; processing the query by at least one of parsing, compiling and executing the query; determining, based on the processing, a query sensitivity level associated with the query based on the at least one data sensitivity level; comparing the user sensitivity level to the query sensitivity level to determine whether the user is authorized to receive a query result based on an execution of the query; and providing the data access control based on the comparison.

In an example, providing data access control may comprise controlling the query result to provide an empty set or other data access controlled query result when the comparison indicates the query sensitivity level is higher than the user sensitivity level.

In an example, the data sensitivity level may be specified by a data sensitivity provider; the user sensitivity level may be specified by a user sensitivity provider; and the data sensitivity provider may be different from the user sensitivity provider.

### V. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method performed by at least one computing device, comprising:
providing data access control by:
receiving a query pertaining to stored data associated with at least one data sensitivity level, the stored data comprising a first data associated with a first data sensitivity level and a second data associated with a second data sensitivity level;
receiving a user sensitivity level for a user;
processing the query;
determining, based on the processing of the query pertaining to the stored data associated with the at least one data sensitivity level, a query sensitivity level associated with the query;
comparing the user sensitivity level to the query sensitivity level; and
providing a query result based on the comparison.

2. The method of claim 1, wherein
the data access control is cloud-based and resource-independent with autonomous specification of user and data sensitivity levels;
the data sensitivity level is specified by a data sensitivity provider;
the user sensitivity level is specified by a user sensitivity provider;
the query sensitivity level is dynamically calculated by a cloud database server; and
the data sensitivity provider is different from the user sensitivity provider.

3. The method of claim 1, wherein the query result comprises:
an empty set or other data access controlled query result when the comparison indicates the query sensitivity level is higher than the user sensitivity level; and
a query result based on execution of the query when the comparison indicates the query sensitivity level is the same or lower than the user sensitivity level.

4. The method of claim 1, wherein the determining of the query sensitivity level comprises determining the query sensitivity level before determining a query result based on execution of the query.

5. The method of claim 4, wherein the determining of the query sensitivity level is based on parsing the query.

6. The method of claim 4, wherein the determining of the query sensitivity level is based on compiling the query.

7. The method of claim 1, wherein the determining of the query sensitivity level is based on executing the query.

8. The method of claim 1, wherein the determining of the query sensitivity level is based on stored data that would be or is accessed to execute the query.

9. The method of claim 1, wherein the determining of the query sensitivity level is based on stored data that would be or is in a query result based on execution of the query.

10. The method of claim 1, wherein the query sensitivity level is based on a maximum data sensitivity level in the at least one data sensitivity level associated with stored data that would be or is (i) read or accessed during the processing of the query or (ii) in the query result based on execution of the query.

11. The method of claim 1, wherein the user sensitivity is received in an access token.

12. The method of claim 1, wherein the user sensitivity is received from a user sensitivity provider.

13. A database server, comprising:
a database configured to:
store data associated with at least one data sensitivity level, the stored data comprising a first data associated with a first data sensitivity level and a second data associated with a second data sensitivity level;
a query processor configured to:
receive a query; and
process the query to generate a query result;
a data access controller configured to:
receive a user access token associated with a user;
receive a user sensitivity level for the user;
determine a query sensitivity associated with the query;
compare the user sensitivity to the query sensitivity; and
provide data access control based on the comparison.

14. The database server of claim 13, wherein the user access token comprises the user sensitivity level.

15. The database server of claim 13, wherein the query sensitivity level is determined before the query processor generates the query result based on parsing or compiling the query.

16. The database server of claim 13, wherein the data access control comprises controlling the query result to provide an empty set or other data access controlled query result when the comparison indicates the query sensitivity level is higher than the user sensitivity level.

17. The database server of claim 13, wherein the query sensitivity level is based on a maximum data sensitivity level in the at least one data sensitivity level associated with stored data that would be or is (i) read or accessed during the processing of the query or (ii) in the query result based on execution of the query.

18. A computer-readable storage medium having program instructions recorded thereon that, when executed by a processing circuit, perform a method comprising:
receiving a query pertaining to stored data associated with at least one data sensitivity level;
receiving a user sensitivity level for a user;
processing the query by at least one of parsing, compiling and executing the query;
determining, based on the processing, a query sensitivity level associated with the query based on the at least one data sensitivity level;
comparing the user sensitivity level to the query sensitivity level to determine whether the user is authorized to receive a query result based on an execution of the query; and
providing the data access control based on the comparison.

19. The computer-readable storage medium of claim 18, wherein providing data access control comprises controlling the query result to provide an empty set or other data access controlled query result when the comparison indicates the query sensitivity level is higher than the user sensitivity level.

20. The computer-readable storage medium of claim 19, wherein
the data sensitivity level is specified by a data sensitivity provider;
the user sensitivity level is specified by a user sensitivity provider; and
the data sensitivity provider is different from the user sensitivity provider.
